(19) United States
(12) Patent Application Publication
(10) Pub. No.: US 2003/0053282 A1
(43) Pub. Date: Mar. 20, 2003

(54) Unipolar electro-static chuck

(75) Inventor: Young Suk Lee, Sungnam (KR)

Correspondence Address: OSTROLENK FABER GERB & SOFFEN, 1180 AVENUE OF THE AMERICAS, NEW YORK, NY, 100368403

(73) Assignee: Jusung Engineering Co., Ltd.

(21) Appl. No.: 10/228,663

(22) Filed: Aug. 26, 2002

(30) Foreign Application Priority Data
Sep. 1, 2001 (KR) 53722/2001

(51) Int. Cl. H02H 1/00; H01G 2/00

(52) U.S. Cl. 361/234

(57) ABSTRACT

A unipolar electrostatic chuck includes a metal electrode receiving a power supply and a dielectric layer formed on the metal electrode, on which a wafer is mounted, a conductive material being doped on the dielectric layer. Silicon carbide or titanium oxide may be used as the conductive material, and alumina or AIN may be used as a material of the dielectric layer. Dechucking can be made for the wafer even without plasma.

### BACKGROUND OF THE INVENTION

1. Field of the Invention

The present invention relates to a unipolar electro-static chuck, and more particularly, to a unipolar electro-static chuck made of a novel material which is capable of dechucking a wafer without plasma

2. Description of the Background Art

Electro-static chucks are classified into a unipolar electro-static chuck which chucks a wafer by using only one electrode and a bipolar electro-static chuck using two opposite electrodes, according to the number of electrodes.

In case of the unipolar electro-static chuck, a clamping force is very strong, but since it uses only one electrode, chucking and dechucking of a wafer is not possible without plasma. Thus, if plasma dies down, dechucking can not be made, so that the plasma should be generated again for dechucking of a wafer.

Meanwhile, in case of the bipolar electro-static chuck, chucking and dechucking are easily made, but due to its complicated structure, it can be easily out of order. Especially, since a high voltage is applied to the narrow space, a device on the wafer can be damaged.

FIG. 1A is a schematic view of a unipolar electro-static chuck in accordance with a conventional art, and FIG. 1B is a view showing an equivalent circuit of FIG. 1A.

With reference to FIGS. 1A and 1B, a negative voltage is applied to a metal electrode 12 through a voltage source 11, and a dielectric layer 13 is coated on the metal electrode 12.

A wafer 21 is positioned on the dielectric layer 13. A ground plate 14 is installed isolated from the wafer 21. The ground plate 14 can be considered a wall of a process chamber.

After the wafer 21 is placed on the dielectric layer 13, when a process gas is injected into the process chamber and an RF power is applied to a separately prepared plasma electrode (not shown) thereto, plasma 31 is formed inside the process chamber.

The plasma 31 serves as a medium for electrically connecting the ground plate 14 and the wafer 21.

Accordingly, a capacitor is formed with such a structure that the wafer 21 and the metal electrode 12 are formed respectively as a positive electrode and a negative electrode with the dielectric layer 13 interposed therebetween.

Then, a clamping force is generated between the wafer 21 and the metal electrode 12 pulls each other with the dielectric layer 13 therebetween, so that the wafer 21 is chucked on the dielectric layer 13.

In order to move the chucked wafer out of the process chamber, a dechucking process is performed.

The dechucking process is performed reversely to the chucking process. That is, a voltage with a polarity opposite to the voltage (V) applied to the metal electrode 12 when chucking is applied, and at the same time, the plasma is created likewise in the chucking process, so that the clamping force formed between the wafer 21 and the metal electrode 12, making them to pull each other, dies away, thereby dechucking the wafer 21.

As state above, in case of the conventional unipolar electro-static chuck, it has a problem that the dechucking can't be made without the plasma.

### SUMMARY OF THE INVENTION

Therefore, an object of the present invention is to provide a unipolar electro-static chuck that is capable of dechucking a wafer even without plasma.

To achieve these and other advantages and in accordance with the purpose of the present invention, as embodied and broadly described herein, there is provided a unipolar electro-static chuck including a metal electrode receiving a power supply and a dielectric layer formed on the metal electrode, on which a wafer is mounted, a conductive material being doped in the dielectric layer.

In the unipolar electro-static chuck of the present invention, silicon carbide or titanium oxide may be used as the conductive material, and alumina or AIN may be used as a material of the dielectric layer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1A and 1B are drawings illustrating a unipolar electrostatic chuck in accordance with the conventional art; and

FIG. 2 is a schematic view showing a unipolar electro-static chuck in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

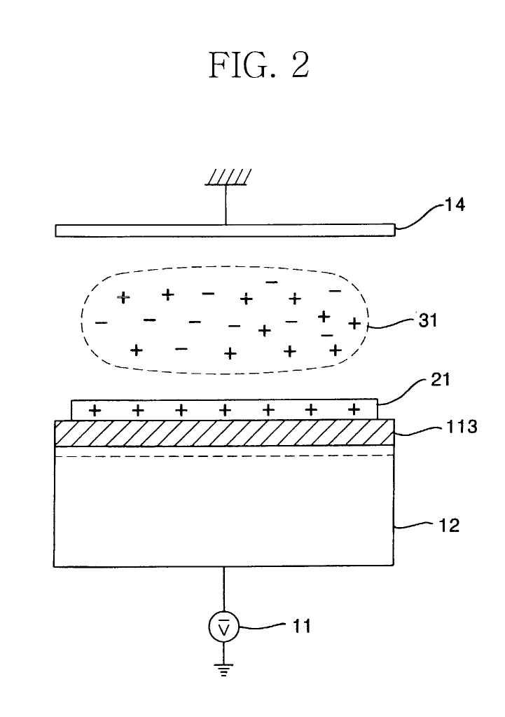

FIG. 2 is a schematic view showing a unipolar electro-static chuck in accordance with the present invention.

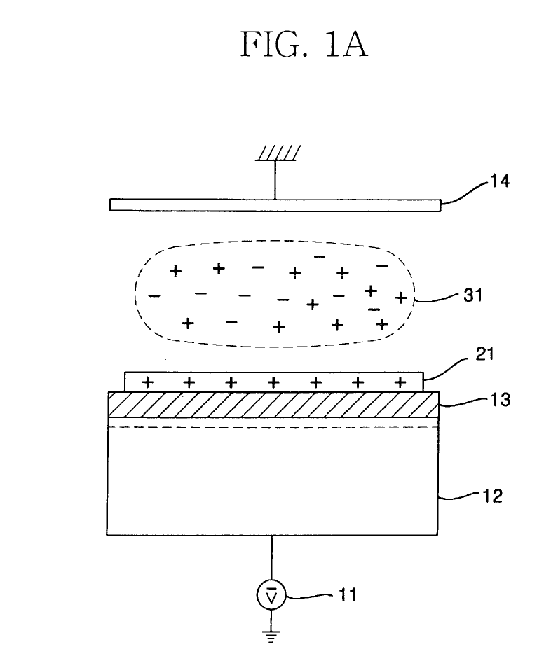

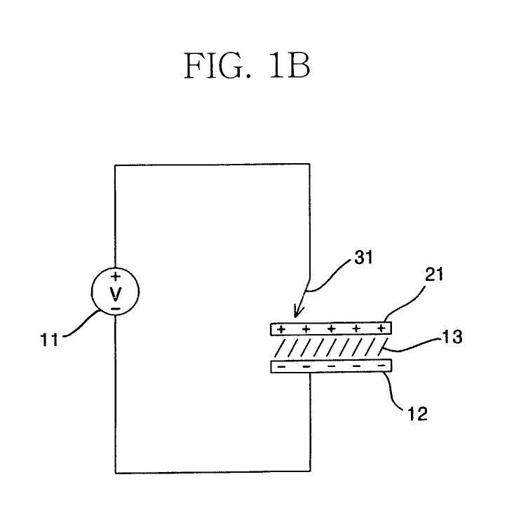

The same reference numerals are given for the same elements performing the same functions as in FIG. 1A of the conventional art, descriptions of which are thus omitted.

With reference to FIG. 2, a dielectric layer 113 is made of alumina or AIN, and a conductive material such as silicon carbide (SiC) or titanium oxide (TixOy) is doped in the dielectric layer 113.

Thus, in dechucking, a voltage opposite to a voltage used for chucking is applied to a metal electrode 12, the electric charges accumulated on the wafer 21 come out through the metal electrode 12 after going through the dielectric layer 113 containing the conductive material. Therefore, dechucking can be made for the wafer even without forming plasma.

As so far described, the unipolar electro-static chuck of the present invention has such an advantage that dechucking can be made for the wafer even without plasma.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A unipolar electro-static chuck comprising:
a metal electrode for receiving a power supply; and
a dielectric layer formed on the metal electrode, on which a wafer is mounted, the dielectric layer being doped with a conductive material therein.

2. The unipolar electro-static chuck of claim 1, wherein the conductive material is silicon carbide or titanium oxide.

3. The unipolar electro-static chuck of claim 1, wherein the dielectric layer is made of alumina or AIN.
